(19) United States
(12) Patent Application Publication
(10) Pub. No.: US 2004/0227961 A1
(43) Pub. Date: Nov. 18, 2004

(54) Card duplicator

(76) Inventor: Ing-Kai Huang, Hsinchu City (TW)

Correspondence Address: YI-WEN TSENG, #D306, 509 ROOSEVELT BLVD., FALLS CHURCH, VA, 22044, US

(21) Appl. No.: 10/437,308

(22) Filed: May 14, 2003

(51) Int. Cl. G06F 15/00; G06F 3/12; G06K 15/02; H04N 1/393; H04N 1/387

(52) U.S. Cl. 358/1.2; 358/1.16; 358/1.18; 358/450; 358/451

(57) ABSTRACT

A card duplicator, particularly an apparatus operative to duplicate small amount of card entities or electronic files with a high speed. The card duplicator has a card input device, a controller, a display, a command input device and a printer output port. The card input device is a scanner, a disk drive, or a compact disk drive that can convert the card entity into an electronic file and input the electronic file into the controller. The electronic file is then displayed by the display. By inputting the number of required copies and the scaling parameter, a printing signal is sent to a printer connected to the printer output port. The cards are then printed by the printer. For each A4 sized paper, ten cards may be printed thereon.

### BACKGROUND OF THE INVENTION

The present invention relates generally to a card duplicator and, more particularly, to a card duplicator comprising a card input device, a controller, a display, a command input device and a printer output port. The card duplicator uses a microprocessor as a control center, and integrates various peripherals input/output (I/O) devices into automatic equipment. The technique of the card duplicator is related to computer and peripherals thereof.

Business cards have been commonly used for self-introduction in the modern society. The conventional business cards are mass produced by printing manufacturers. Such business cards are made through processes including design, type setting, plate making and printing, and are time consuming. Moreover, the production method is not time and cost efficient. To resolve the time and dost efficiency problem, personal computer accompanied with printer and printing software has been applied to provide a brand new process for producing business cards. However, such method is only applicable for designing brand new business cards. For those who prefer using the design of existing business cards and have immediate need to duplicate the existing business cards, the personal computer is inapplicable for being lack of the original file. Therefore, there is a substantially need for developing a card duplicating method accompanied with the application of personal computer and scanner, such that the content of business card is scanned into the computer. By image processing software or card making process, the business card can be printed and duplicated. However, this kind of duplication is limited by the resolution of the scanner. Currently, the scanners available in the market greatly cannot adequately meet with the resolution requirement for duplicating business cards. For example, the scanning dimension of the currently most popular household or personal scanner is the A4 dimension, of which the area is much larger than the business card. To attain the resolution satisfying the requirement of the business card, the price of the scanner is very high. Therefore, it is very uneconomic for buying an expensive scanner solely for duplicating business cards. In addition, the apparatus for duplicating small amount of cards has not been commonly seen in the market currently, while there is a substantially need for duplicating a small amount of business cost without time-consuming process and high cost.

### BRIEF SUMMARY OF THE INVENTION

The present invention provides a card duplicator that can duplicate cards without tedious and costly processes. By the card duplicator provided in the present invention, a card entity or an electronic file of the card is scanned by a scanner. The scanned data is saved in a disk, a compact disk or a card reader and input to a controller which uses a microprocessor as a kernel. A display is used to display the corresponding status. The user then provides a command indicating the selected scale and number of copies, and uses a printer to print out the cards. Therefore, a small amount of cards can be duplicated on a piece of A4 paper. As the image of the original card can be downscaled or upscaled, and a color jet printer, a color laser printer or other printer can be used to print out the scaled image, the card is easily duplicated. The card duplicator can thus be used by personal, convenient shop, stationary shops to provide a convenient and inexpensive way to duplicate cards.

### BRIEF DESCRIPTION OF THE DRAWINGS

These, as well as other features of the present invention, will become more apparent upon reference to the drawings wherein:

FIG. 1 shows a block diagram of the card duplicator provided by the present invention;

FIG. 2 shows the operation flow the card duplicator; and

FIG. 3 shows the exterior feature of a card duplicator of a preferred embodiment of the present invention.

### DETAILED DESCRIPTION OF THE INVENTION

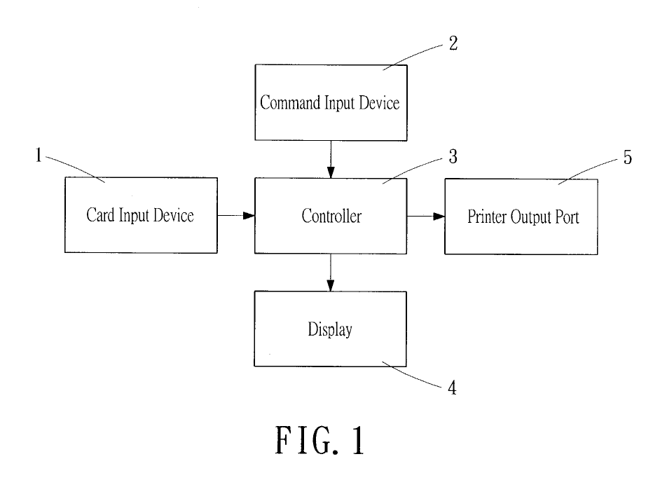

As shown in FIG. 1, the card duplicator provided by the present invention comprises a card input device 1, a command input device 2, a controller 3, a display 4 and a printer output port 5. The card input device 1 includes a scanner which scans a card entity into an electronic file and input the electronic file into the controller 3. Alternatively, a USB port is connected to an external drive as an external scanner, a disk, a compact disk, or a card reader to read the electronic file saved in a disk, compact disk, or a memory card, and input the electronic file into the controller. The controller 3 includes a small computer that uses a microprocessor as a kernel. According to the edit command input from the command input device 2, the original electronic file is edited. The edit command includes the scale ratio and number of required copies, for example. After demagnifying or magnifying the electronic file with a certain ratio, and sorting the electronic file according to the number of required copies, an image signal is output to the display 4 to display the corresponding status. The display 4 includes a liquid crystal display (LCD), a cathode ray tube (CRT), or other displays. The command input device 2 includes a keyboard, a mouse, a touchpad or a touch screen, for example, allowing direction, number and confirmation commands to be input. When the user confirms the input commands for printing, the controller 3 outputs a printing signal to the printer output port 5. The cards are then printed out by the printer connected to the printer output port 5. Preferably, tens of cards can be printed on each sheet of A4 sized paper to provide an urgent need of a small amount.

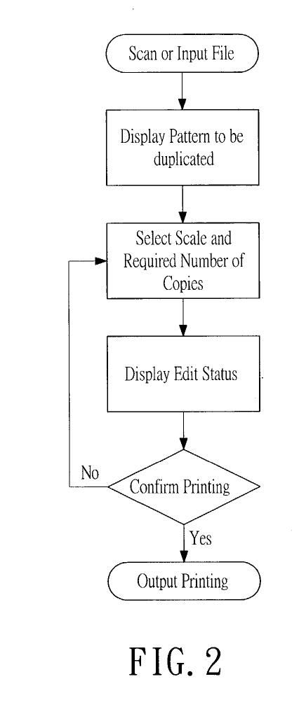

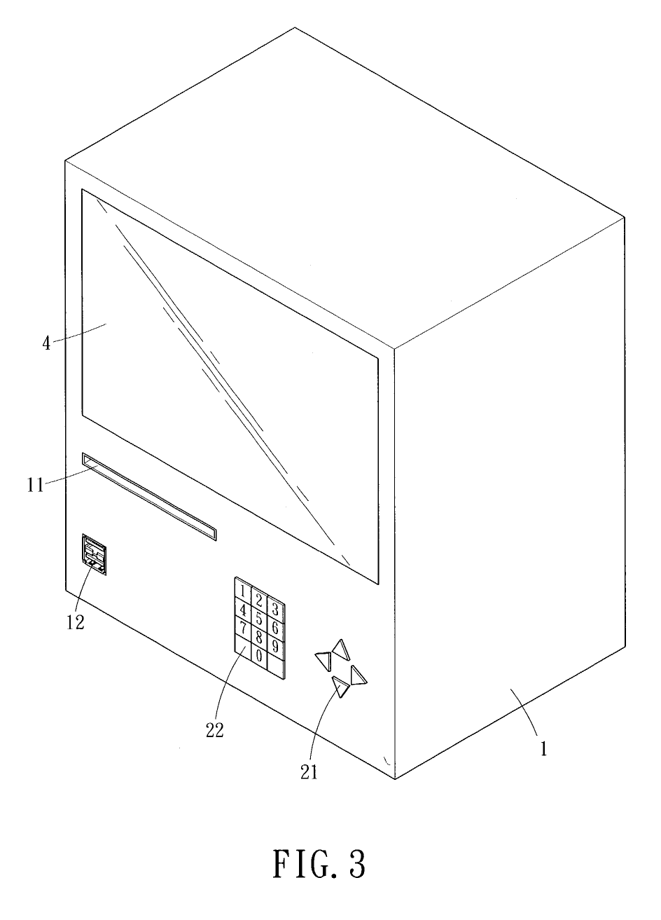

FIG. 2 shows the operation flow of the present invention. The user only needs to input require scale and number of copies to finish duplication of cards in a short time. FIG. 3 shows an exterior feature of the present invention. As shown, the card duplicator includes a rectangular machine with a front side, on which the display 4 is installed. Underneath the display 4, a card input slot 11 is formed on a panel for feeding a card entity into the scanner (not shown). When the card entity is inserted into the card input slot 11, the image of the card is scanned, and the scanning process is complete, the card is ejected. The scanner includes a feeder type scanner, for example. A port 12 may also be formed on the panel, allowing an external input device such as a disk drive, a compact disk drive, and a card reader to input an electronic file into the card duplicator from storage medium. The card duplicator may also comprise built-in disk drive, compact disk driver or card reader for reading file from a storage medium such as a disk, a compact disk or a memory card, respectively. As shown, the panel further comprises a direction key 21 and a number keypad 22 allowing the user to input scale and number parameters. The controller 3 and the printer output port 5 are installed in the machine and on a rear panel thereof. It is appreciated that the shape of the machine, the card input devices 11 and 12, and the command input devices 21 and 22 are only exemplarily illustrated and described. Modification upon such devices can be made according to specific requirements without exceeding the spirit or scope of the present invention.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

What is claimed is:

1. A card duplicator, comprising:
a card input device, including a scanner and at least one input device, the scanner being operative to scan a card entity into an electronic file, and the input device being operative to directly input an electronic file saved in a storage medium;
a controller, using a microprocessor as a kernel thereof, the controller being operative to receive the electronic file input from the card input device, and to execute edition on the electronic file to output an image signal;
a command input device, operative to input an edit command to the controller;
a display, operative to receive the image signal output from the controller to display corresponding execution status; and
a printer output port, electronic connected to the controller and output a print signal to the printer.

2. The card duplicator of claim 1, further comprising a USB port for connecting an external input device.

3. The card duplicator of claim 1, wherein the display includes a liquid crystal display or a cathode ray tube.

4. The card duplicator of claim 1, wherein the edit command includes parameters of scale and required number of copies.

5. The card duplicator of claim 1, wherein the input device includes a disk drive, a compact disk driver or a card reader.

6. The card duplicator of claim 1, wherein the storage medium includes a disk, a compact disk, or a memory card.

7. The card duplicator of claim 1, wherein the scanner comprises a card insert slot for receiving the card to scan and ejecting the card after scanning.
